(19) United States
(12) Patent Application Publication
(10) Pub. No.: US 2022/0109694 A1
(43) Pub. Date: Apr. 7, 2022

(54) COMMUNICATION SYSTEM, COMMUNICATION METHOD, AND NON-TRANSITORY COMPUTER READABLE MEDIUM STORING COMMUNICATION PROGRAM

(71) Applicant: NEC Corporation, Tokyo (JP)

(72) Inventor: Naoyuki TAKEICHI, Tokyo (JP)

(73) Assignee: NEC Corporation, Tokyo (JP)

(21) Appl. No.: 17/488,561

(22) Filed: Sep. 29, 2021

(30) Foreign Application Priority Data
Oct. 2, 2020 (JP) 2020-167672

(51) Int. Cl. H04L 29/06

(52) U.S. Cl. CPC H04L 63/166; H04L 63/0236; H04L 63/02

(57) ABSTRACT

A communication system 1 using an FTPS according to an embodiment of the present disclosure includes a server 10 having a plurality of ports, and a firewall 20 functioning between the server 10 and a client 30. The server 10 transmits, upon receiving a command transmitted by the client 30, identification information of one of the plurality of ports in an unencrypted state to the firewall 20. The firewall 20 validates, upon receiving the port identification information from the server 10, data transfer from the client 30 to the port, which is represented by the port identification information, of the server 10.

### INCORPORATION BY REFERENCE

This application is based upon and claims the benefit of priority from Japanese patent application No. 2020-167672, filed on Oct. 2, 2020, the disclosure of which is incorporated herein in its entirety by reference.

### TECHNICAL FIELD

The present disclosure relates to a communication system, a communication method, and a communication program, and particularly to a communication system using a file transfer protocol compatible with cryptographic technique, a communication method, and a non-transitory computer readable medium storing a communication program.

### BACKGROUND ART

Conventionally, an FTP (file transfer protocol) has been used in a client server system. In the client server system using the FTP, a passive mode for accepting connection to a port of a server has been adopted only on the server side.

In the FTP, communication is performed with encryption not performed. In the passive mode, the server provides a port number of the server to be used for file transfer to a firewall on the server side. The firewall on the server side performs setting for validating packet transfer to a port represented by the port number of the server. Then, the firewall on the server side transfers, upon receiving a packet including a port number of the server from a client, the packet received from the client to the port represented by the port number of the server based on the port number of the server and the above-described setting.

In recent years, a communication system using a file transfer protocol compatible with cryptography has been used due to an increased demand for information security. Examples of the file transfer protocol include an FTPS (FTP over SSL (secure socket layer)/TLS (Transport Layer Security)) compatible with the FTP in an application layer. In the FTPS, communication data is encrypted using the SSL/TLS.

When the passive mode is used in the client server system using the FTPS, the server transmits to the firewall on the server side a port number to be used for file transfer in an encrypted state. Accordingly, if the firewall on the server side does not include decoding means, the firewall on the server side cannot grasp the port number to be used for file transfer, and cannot validate packet transfer to a port represented by the port number. That is, there has been a problem that the firewall on the server side cannot control data transfer from the client to a specific port of the server.

In this regard, Japanese Unexamined Patent Application Publication No. 2005-167816 discloses a relay system conforming to an FTP. However, the relay system disclosed in this Japanese Unexamined Patent Application Publication cannot solve the above-described problem because it is neither a client server system using an FTPS nor a system including a firewall on the server side.

The present disclosure has been made in view of the above-described problem, and is directed to providing, in a communication system using an FTPS, a communication system capable of controlling data transfer from a client to a specific port of a server, a communication method, and a non-transitory computer readable medium storing a communication program.

### SUMMARY

A communication system according to an example aspect of the present disclosure is a communication system using an FTPS, the communication system including a server having a plurality of ports, and a firewall functioning between the server and a client, in which the server transmits, upon receiving a command transmitted by the client, identification information of one of the plurality of ports in an unencrypted state to the firewall, and the firewall validates, upon receiving the port identification information from the server, data transfer from the client to the port, which is represented by the port identification information, of the server.

A communication method according to an example aspect of the present disclosure includes a server having a plurality of ports using an FTPS receiving a command from a client via a firewall functioning between the server and a client, the server transmitting identification information of one of the plurality of ports in an unencrypted state to the firewall, the firewall receiving identification information of the port of the server from the client, and the firewall validating data transfer from the client to the port, which is represented by the port identification information, of the server.

Further, a communication program according to an example aspect of the present disclosure is a communication program to be executed by an information processing device functioning as a server having a plurality of ports using an FTPS, the communication program causing the information processing device to perform to receive a command transmitted by a client, and transmit identification information of one of the plurality of ports in an unencrypted state to a firewall included in the information processing device so that the firewall validates data transfer from the client to the port, which is represented by the port identification information, of the server.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a schematic view illustrating a first example embodiment of a communication system according to the present disclosure;

FIG. 2 is a block diagram illustrating a configuration of a server according to the first example embodiment of the present disclosure;

FIG. 3 is a block diagram illustrating a configuration of a firewall according to the first example embodiment of the present disclosure;

FIG. 4 is a block diagram illustrating main components in the communication system according to the first example embodiment of the present disclosure;

FIG. 5 is a diagram illustrating an example of processing to be performed by the firewall according to the first example embodiment of the present disclosure;

FIG. 6 is a diagram illustrating an example of information to be provided to the firewall by a server according to the first example embodiment of the present disclosure;

FIG. 7 is a diagram illustrating another example of processing to be performed by the firewall according to the first example embodiment of the present disclosure;

FIG. 8 is a diagram illustrating another example of processing to be performed by the firewall according to the first example embodiment of the present disclosure;

FIG. 9 is a diagram illustrating another example of processing to be performed by the firewall according to the first example embodiment of the present disclosure;

FIG. 10 is a diagram illustrating an example of processing to be performed in the communication system according to the first example embodiment of the present disclosure; and

FIG. 11 is a block diagram illustrating a configuration of a server according to a second example embodiment of the present disclosure.

### EMBODIMENTS

### First Example Embodiment

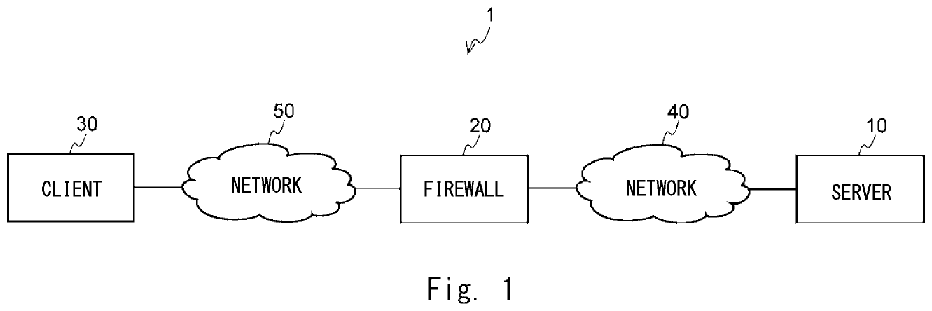

A first example embodiment of the present disclosure will be described below with reference to the drawings. FIG. 1 is a schematic view illustrating a first example embodiment of a communication system according to the present disclosure. The communication system 1 is a communication system using an FTPS compatible with an FTP in an application layer.

The communication system 1 includes a server 10, a firewall 20 on the server side, and a client 30. The server 10 and the firewall 20 communicate data to each other via a network 40. The network 40 includes a network such as a LAN (Local Area Network). The firewall 20 and the client 30 communicate data to each other via a network 50. The network 50 includes a network such as the Internet. The client 30 may perform data communication with the firewall 20 on the server side via a firewall on the client side.

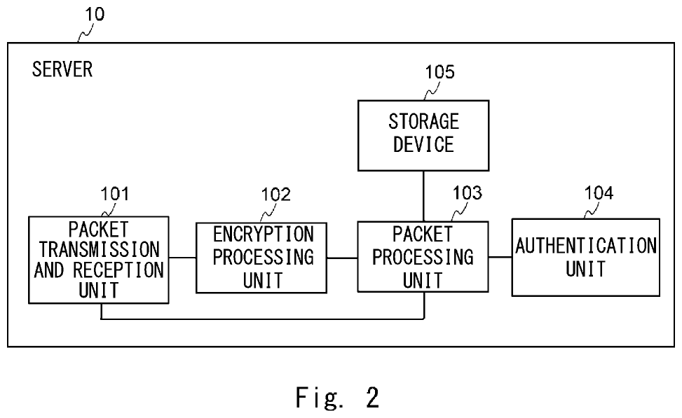

The server 10 is an information processing device that provides target data to the client 30 in response to a data acquisition request from the client 30. Specific examples of the server 10 include an FTPS server. Details of the server 10 will be described below with reference to FIG. 2.

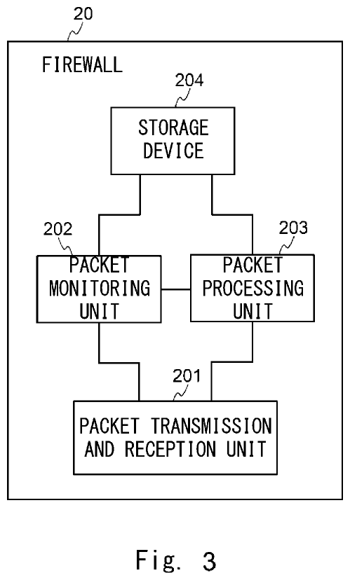

The firewall 20 is an information processing device functioning as a firewall of the server 10. Details of the firewall 20 will be described below with reference to FIG. 3.

The client 30 is an information processing device that acquires desired data from the server 10. Specific examples of the server 10 include various information processing devices such as a PC (Personal Computer), a tablet terminal, and a smartphone. The client 30 transmits predetermined commands as preprocessing for acquiring data from the server 10. The predetermined commands include commands such as an NAT (Network Address Translation), an NAPT (Network Address Port Translation), and an EPSV command (defined by RFC2428) compatible with IPv6 in addition to a PASV command (defined by RFC959).

FIG. 2 is a block diagram illustrating a configuration of the server 10 according to the first example embodiment of the present disclosure. The server 10 includes a plurality of packet transmission and reception units 101, an encryption processing unit 102, a packet processing unit 103, an authentication unit 104, and a storage device 105. An arithmetic device (not illustrated) such as a CPU (Central Processing Unit) or an MPU (Micro Processing Unit) included in the server 10 executes a program stored in the storage device 105 so that such functional units can be implemented. The functional units may be implemented using an integrated circuit such as an FPGA (Field-Programmable Gate Array) or an ASIC (Application Specific Integrated Circuit).

The storage device 105 is a storage device storing information such as a communication program according to the first example embodiment of the present disclosure, target data to be requested by the client 30, and various setting information. The arithmetic device in the server 10 reads out and executes the communication program from the storage device 105, to perform a communication method according to the first example embodiment of the present disclosure.

The plurality of packet transmission and reception units 101 are each a functional unit that transmits and receives a packet between the server 10 and the firewall 20. In FIG. 2, only one of the packet transmission and reception units 101 is illustrated for simplicity of description. The plurality of packet transmission and reception units 101 each function as a port of the server 10. The plurality of ports of the server 10 include a dedicated port to be used to provide the target data and the ports respectively used for other communications.

The packet transmission and reception unit 101 provides the packet received from the firewall 20 to the encryption processing unit 102 or the packet processing unit 103. The packet transmission and reception unit 101 provides, upon receiving the encrypted packet, the encrypted packet to the encryption processing unit 102. On the other hand, the packet transmission and reception unit 101 provides, upon receiving an unencrypted packet, the unencrypted packet to the packet processing unit 103.

The encryption processing unit 102 is a functional unit that encrypts and decrypts a packet. The encryption processing unit 102 decrypts, upon receiving the encrypted packet from the packet transmission and reception unit 101, the packet, and provides the decrypted packet to the packet processing unit 103.

The encryption processing unit 102 encrypts, upon receiving identification information of a specific port of the server 10 from the packet processing unit 103, the identification information of the specific port, and transmits the encrypted identification information to the firewall 20 via the packet transmission and reception unit 101. The encryption processing unit 102 encrypts, upon receiving the target data requested by the client 30 from the packet processing unit 103, the target data, and transmits the encrypted target data to the firewall 20 via the packet transmission and reception unit 101.

The packet processing unit 103 is a functional unit that establishes communication connection between the server 10 and the client 30 and provides the identification information of the specific port of the server 10, identification information of a protocol to be used to provide data to the client 30, an IP address of the client 30, and the target data requested by the client 30.

The packet processing unit 103 provides, upon receiving the above-described predetermined command, the identification information of the specific port of the server 10 to the packet transmission and reception unit 101 without via the encryption processing unit 102. In this case, the packet transmission and reception unit 101 transmits to the firewall 20 unencrypted information including the identification information, which remains unencrypted, of the specific port of the server 10.

The packet processing unit 103 provides, upon receiving the above-described predetermined command, the identification information of the specific port of the server 10 to the encryption processing unit 102. In this case, the encryption processing unit 102 encrypts the identification information of the port of the server 10 and transmits the encrypted identification information of the port of the server 10 to the firewall 20.

Further, the packet processing unit 103 acquires, upon receiving the data acquisition request transmitted by the client 30, the requested target data from the storage device 105, and provides the target data to the encryption processing unit 102.

The authentication unit 104 is a functional unit that authenticates the client 30 which requests communication connection with the server 10.

FIG. 3 is a block diagram illustrating a configuration of the firewall 20 according to the first example embodiment of the present disclosure. The firewall 20 includes a packet transmission and reception unit 201, a packet monitoring unit 202, a packet processing unit 203, and a storage device 204. An arithmetic device (not illustrated) such as a CPU or an MPU included in the firewall 20 executes a program stored in the storage device 204 so that such functional units can be implemented. The functional units may be implemented using an integrated circuit such as an FPGA or an ASIC.

The storage device 204 is a storage device storing the communication program according to the first example embodiment of the present disclosure and various setting information. The arithmetic device in the firewall 20 reads out and executes the communication program from the storage device 204, to perform the communication method according to the first example embodiment of the present disclosure.

The packet transmission and reception units 201 is a functional unit that transmits and receives a packet between the firewall 20 and each of the server 10 and the client 30. The packet transmission and reception unit 201 provides the packet received from each of the server 10 and the client 30 to the packet monitoring unit 202.

The packet monitoring unit 202 is a functional unit that monitors the packet from each of the server 10 and the client 30. If setting information indicating that data transfer from the client 30 to the specific port of the server 10 is validated is stored in the storage device 204, the packet monitoring unit 202 requests the packet processing unit 203 to validate data transferring to the specific port.

The packet processing unit 203 is a functional unit that transfers a packet between the server 10 and the client 30 and validates and invalidates packet transfer from the client 30 to the server 10. The packet processing unit 203 validates, when requested to validate data transfer from the packet monitoring unit 202 to the specific port of the server 10, data transfer from the client 30 to the specific port of the server 10 using identification information of the specific port of the server 10, which has been received from the server 10. Specifically, the packet processing unit 203 stores in the storage device 204 setting information (hereinafter referred to as “validation setting information”) including the identification information of the specific port received from the server 10 and information indicating that packet transfer to the specific port is valid.

Then, the packet processing unit 203 controls, upon receiving a data acquisition request from the client 30 to the server 10, transferring of the data acquisition request to the server 10 based on port identification information received together with the data acquisition request and the validation setting information.

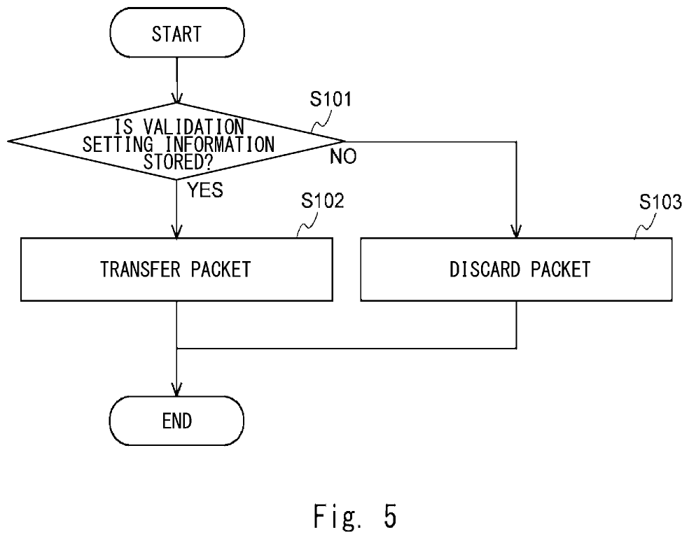

Specifically, as illustrated in FIG. 5, the packet processing unit 203 determines in step S101 whether or not validation setting information indicating that packet transfer to a port represented by port identification information received together with the data acquisition request is valid is stored in the storage device 204. If the validation setting information is stored in the storage device 204 (YES), the packet processing unit 203 transfers the data acquisition request to the port in step S102. On the other hand, if the validation setting information is not stored in the storage device 204 (NO), the packet processing unit 203 discards the data acquisition request in step S103.

In another example, the packet processing unit 203 can validate, using identification information of a specific port of the server 10, which have been received from the server 10, and identification information of a specific protocol, data transfer from the client 30 to the specific port of the server 10. In this case, the server 10 transmits to the firewall 20 the identification information of the specific port and the identification information of the protocol to be used to provide data to the client 30 each in an unencrypted state. The specific protocol can be designated by a manager of the server 10.

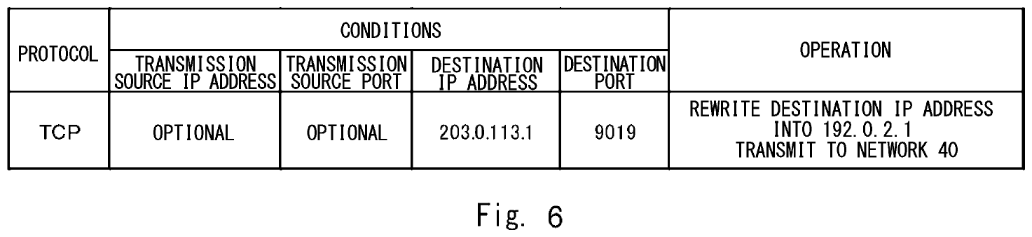

Specifically, the packet processing unit 203 stores setting information including the identification information of the specific port received from the server 10, the identification information of the specific protocol, and information indicating that packet transfer to the specific port is valid as validation setting information in the storage device 204. For example, the server 10 can provide information illustrated in FIG. 6 to the firewall 20. In an example illustrated in FIG. 6, “9019” is designated as the specific port of the server 10, and “TCP” is designated as the protocol. An IP address of the server 10 is “192.0.2.1”, and an IP address on the network 50 side of the firewall 20 is “203.0.113.1”. Although a transmission source IP address has not yet been designated in the example illustrated in FIG. 6, an IP address of the client 30 may be designated.

Then, the packet processing unit 203 controls, upon receiving a data acquisition request from the client 30 to the server 10, transferring of the data acquisition request to the server 10 based on port identification information received together with the data acquisition request, a protocol used to transmit the data acquisition request, and the validation setting information.

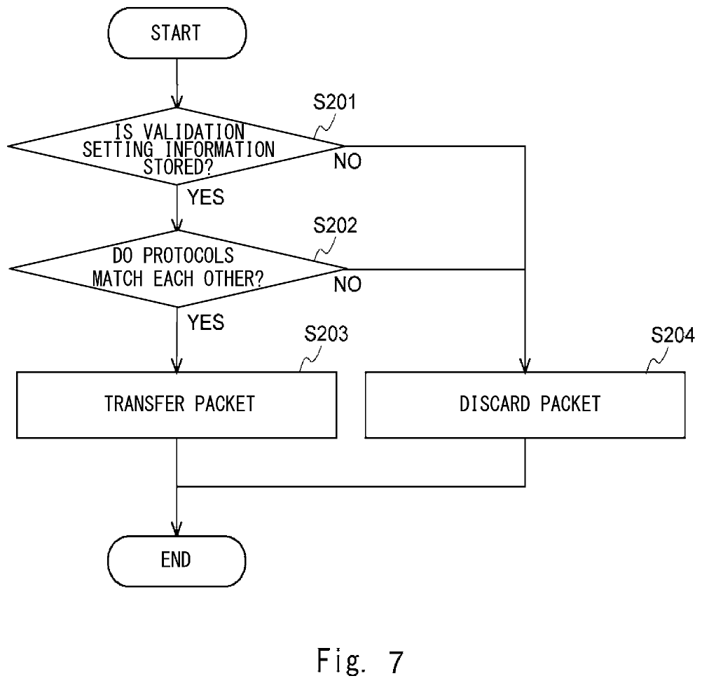

Specifically, as illustrated in FIG. 7, the packet processing unit 203 determines in step S201 whether or not validation setting information indicating that packet transfer to a port represented by port identification information received together with the data acquisition request is valid is stored in the storage device 204. If the validation setting information is not stored (NO), the packet processing unit 203 discards the data acquisition request in step S204.

On the other hand, if the validation setting information is stored (YES), the packet processing unit 203 determines in step S202 whether or not a protocol used to transmit the data acquisition request and a protocol included in the validation setting information match each other. If these protocols match each other (YES), the packet processing unit 203 transfers the data acquisition request to the port in step S203. On the other hand, if these protocols differ from each other (NO), the packet processing unit 203 discards the data acquisition request in step S204.

In still another example, the packet processing unit 203 can validate, using identification information of a specific port of the server 10, which has been received from the server 10, and an IP address of the client 30, data transfer from the client 30 to the specific port of the server 10. In this case, the server 10 transmits to the firewall 20 the identification information of the specific port and the IP address of the client 30 each in an unencrypted state. Specifically, the packet processing unit 203 stores setting information including the port identification information received from the server 10, the IP address of the client 30, and information indicating that packet transfer to the specific port is valid as validation setting information in the storage device 204.

Then, the packet processing unit 203 controls, upon receiving a data acquisition request from the client 30 to the server 10, transferring of the data acquisition request to the server 10 based on port identification information received together with the data acquisition request, the IP address of the client 30, and the validation setting information.

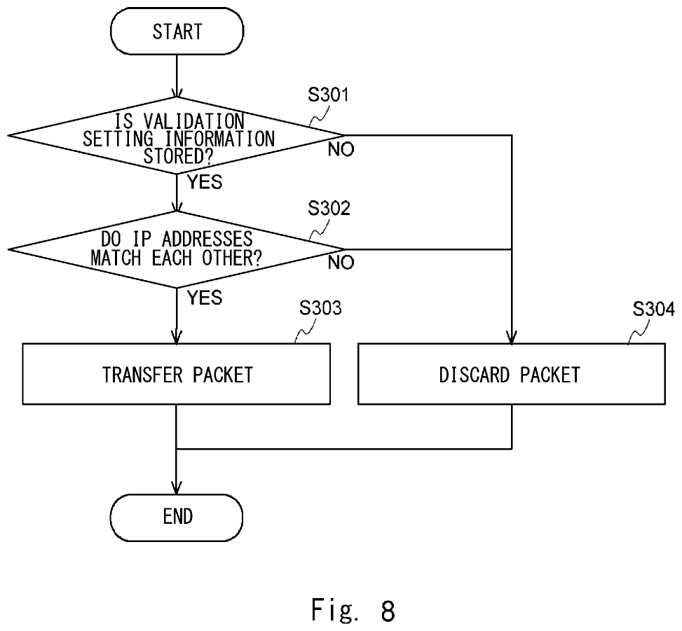

Specifically, as illustrated in FIG. 8, the packet processing unit 203 determines in step S301 whether or not validation setting information indicating that packet transfer to a port represented by port identification information received together with the data acquisition request is valid is stored in the storage device 204. If the validation setting information is not stored (NO), the packet processing unit 203 discards the data acquisition request in step S304. On the other hand, if the validation setting information is stored (YES), the packet processing unit 203 determines in step S302 whether or not a transmission source IP address of the data acquisition request and an IP address of the client 30 included in the validation setting information match each other. If the IP addresses match each other (YES), the packet processing unit 203 transfers the data acquisition request to the port in step S303. On the other hand, if the IP addresses differ from each other (NO), the packet processing unit 203 discards the data acquisition request in step S304.

In still another example, the packet processing unit 203 can validate, using identification information of a specific port of the server 10, which has been received from the server 10, identification information of a specific protocol, and an IP address of the client 30, data transfer from the client 30 to the specific port of the server 10. In this case, the server 10 transmits to the firewall 20 the identification information of the specific port, the identification information of the protocol to be used to provide data to the client 30, and the IP address of the client 30 each in an unencrypted state. The specific protocol can be designated by a manager of the server 10.

Specifically, the packet processing unit 203 stores setting information including the port identification information received from the server 10, the identification information of the specific protocol, the IP address of the client 30, and information indicating that packet transfer to the specific port is valid as validation setting information in the storage device 204.

Then, the packet processing unit 203 controls, upon receiving a data acquisition request from the client 30 to the server 10, transferring of the data acquisition request to the server 10 based on port identification information received together with the data acquisition request, a protocol used to transmit the data acquisition request, and the validation setting information.

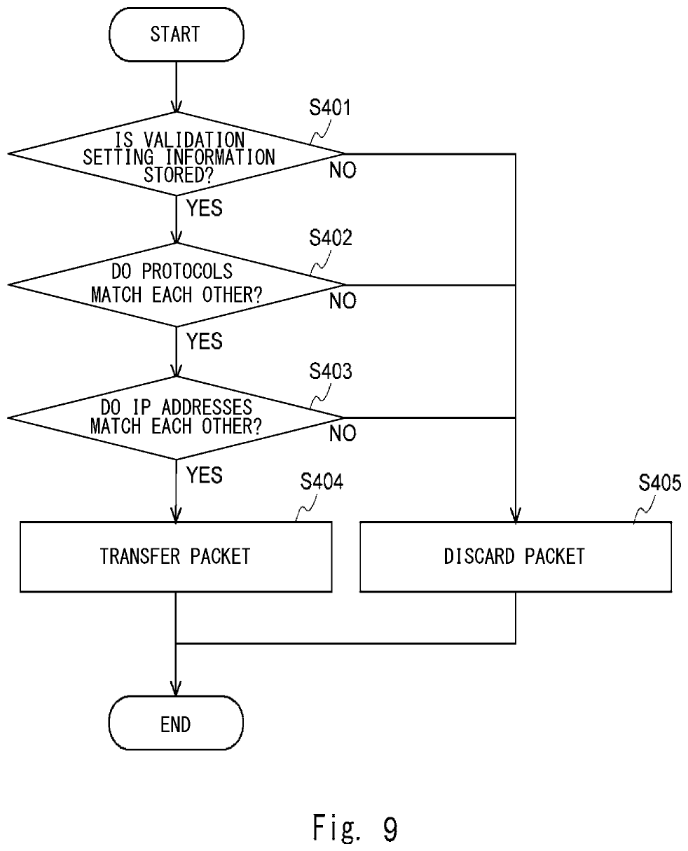

Specifically, as illustrated in FIG. 9, the packet processing unit 203 determines in step S401 whether or not validation setting information indicating that packet transfer to a port represented by port identification information received together with the data acquisition request is valid is stored in the storage device 204. If the validation setting information is not stored (NO), the packet processing unit 203 discards the data acquisition request in step S405.

On the other hand, if the validation setting information is stored (YES), the packet processing unit 203 determines in step S402 whether or not a protocol used to transmit the data acquisition request matches a protocol included in the validation setting information. If these protocols differ from each other (NO), the packet processing unit 203 discards the data acquisition request in step S405.

On the other hand, if these protocols match each other (YES), the packet processing unit 203 determines in step S403 whether or not an IP address of the client 30 which has transmitted the data acquisition request matches an IP address of the client 30 included in the validation setting information. If the IP addresses match each other (YES), the packet processing unit 203 transfers the data acquisition request to the port in step S404. On the other hand, if the IP addresses differ from each other (NO), the packet processing unit 203 discards the data acquisition request in step S405.

The packet processing unit 203 discards, when a predefined time period has elapsed from a time point where identification information of a specific port is received from the server 10, validation setting information associated with the port identification information stored in the storage device 204, to invalidate data transfer from the client 30 to the specific port. Then, the packet processing unit 203 does not transfer, even if it receives the data acquisition request from the client 30 to the server 10, the data acquisition request to the specific port.

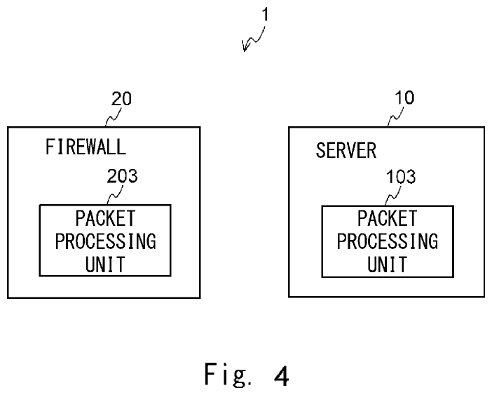

FIG. 4 is a block diagram illustrating main components included in the communication system 1 according to the first example embodiment of the present disclosure. The communication system 1 includes the server 10 including the packet processing unit 103 and the firewall 20 including the packet processing unit 203.

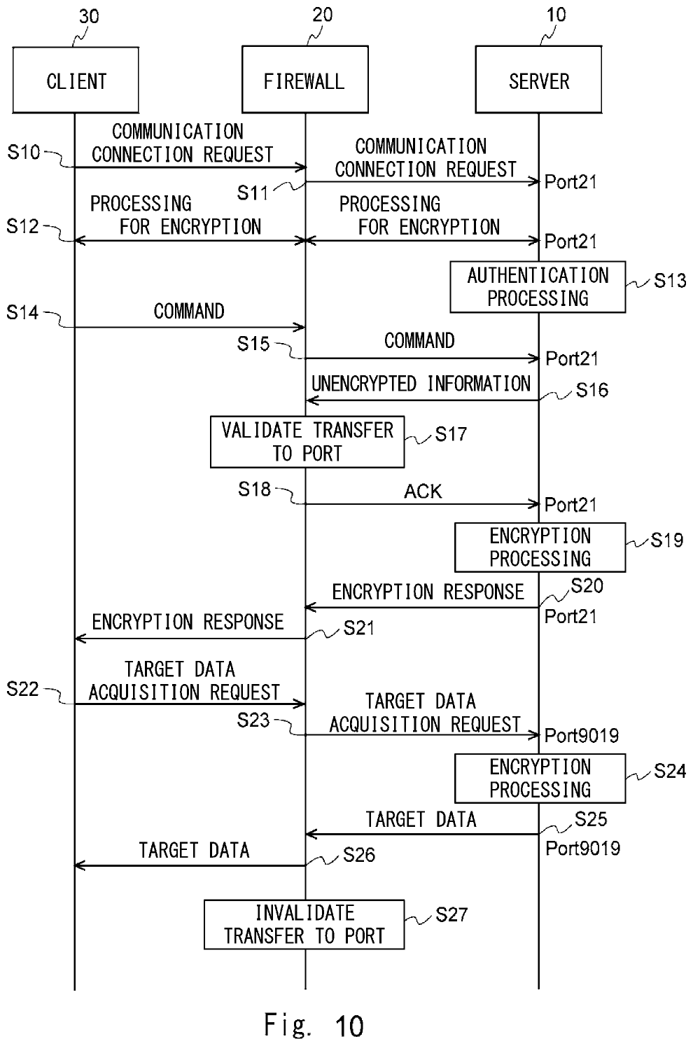

FIG. 10 is a flowchart illustrating an example of processing to be performed in the communication system 1. In step S10, the client 30 transmits a communication connection request. When the packet monitoring unit 202 in the firewall 20 detects the communication connection request transmitted by the client 30, the packet processing unit 203 transfers the communication connection request to one port (Port21 in an example illustrated in FIG. 10) of the server 10 in step S11. The port is a port not to be used to provide target data.

In step S12, the packet processing unit 103 in the server 10 and the client 30 each perform processing required for encryption communication such as key exchange. In the processing, the port (Port21) is used. In step S13, the authentication unit 104 in the server 10 performs authentication processing for authenticating the client 30. When the client 30 is authenticated, the following processing is performed.

In step S14, the client 30 transmits a command to the firewall 20. When the packet monitoring unit 202 in the firewall 20 detects the command transmitted by the client 30, the packet processing unit 203 transfers the command to the port (Port21) of the server 10 via the packet transmission and reception unit 201 in step S15. The command includes an IP address of the client 30.

When the server 10 receives the command from the firewall 20, the packet processing unit 103 selects identification information of a specific port among ports of the server 10 in step S16, and transmits unencrypted information including the identification information of the specific port to the firewall 20 via the port (Port21). The packet processing unit 103 selects identification information of a dedicated port (Port9019 in the example illustrated in FIG. 10) to be used to provide the target data among the ports of the server 10.

When the packet monitoring unit 202 in the firewall 20 detects the unencrypted information transmitted by the server 10, the packet processing unit 203 validates data transfer to the port (Port9019) represented by the port identification information included in the unencrypted information in step S17.

In step S18, the packet processing unit 203 in the firewall 20 transmits ACK (acknowledgement) for the unencrypted information to the server 10 via the packet transmission and reception unit 201. When the server 10 receives the ACK for the unencrypted information from the firewall 20, the packet processing unit 103 provides a response including the port identification information selected in step S16 to the encryption processing unit 102 in step S19, and the encryption processing unit 102 encrypts the response. In step S20, the encryption processing unit 102 transmits the encrypted response to the firewall 20 via the port (Port21).

In another example, the firewall 20 need not transmit the ACK for the unencrypted information to the server 10. In this case, the server 10 transmits the unencrypted information to the firewall 20, and then transmits the encrypted response to the firewall 20.

When the packet monitoring unit 202 in the firewall 20 detects the encrypted response transmitted by the server 10, the packet processing unit 203 transmits the encrypted response to the client 30 via the packet transmission and reception unit 201 in step S21.

The client 30 transmits, upon receiving the encrypted response from the firewall 20, identification information of a specific port included in the encrypted response and a request to acquire encrypted target data to the firewall 20 in step S22. When the packet monitoring unit 202 in the firewall 20 detects the target data acquisition request transmitted by the client 30, the packet processing unit 203 determines in step S23 whether or not the target data acquisition request is transferred to the server 10 based on the port identification information received together with the target data acquisition request and validation setting information stored in the storage device 204. If the target data acquisition request is transferred to the server 10, the packet processing unit 203 transfers the target data acquisition request to the port (Port9019) of the server 10 via the packet transmission and reception unit 201.

When the server 10 receives the target data acquisition request from the firewall 20, the packet processing unit 103 acquires the target data from the storage device 105 and provides the acquired target data to the encryption processing unit 102 and the encryption processing unit 102 encrypts the target data in step S24. In step S25, the encryption processing unit 102 transmits the encrypted target data to the firewall 20 via the port (Port9019).

When the packet monitoring unit 202 in the firewall 20 detects the target data transmitted by the server 10, the packet processing unit 203 transmits the target data to the client 30 via the packet transmission and reception unit 201 in step S26. When a predefined time period has elapsed from a time point where data transfer to the port (Port9019) is validated in step S17, the firewall 20 invalidates data transferring to the port (Port9019) in step S27.

In the above-described embodiment, the server 10 transmits, upon receiving the command transmitted by the client 30, the identification information of the specific one port among the plurality of ports in an unencrypted state to the firewall 20. The firewall 20 validates, upon receiving the port identification information from the server 10, data transfer from the client 30 to the specific port represented by the port identification information. As a result, the firewall 20 can control data transferring from the client 30 to the specific port of the server 10.

In this configuration, the firewall 20 does not transfer the port identification information, which remains unencrypted, received from the server 10, to the client 30. Accordingly, an opportunity for the port identification information that remains unencrypted to be received can be reduced so that security of the communication system can be enhanced.

The server 10 does not release the plurality of ports but releases only the one specific port in response to the command transmitted by the client 30. Accordingly, a possibility that an access is made in an unauthorized manner via the released port can be reduced so that security can be enhanced.

Further, the identification information of the specific port of the server 10 is provided in an unencrypted state to the firewall 20. Thus, the firewall 20 need not perform decryption processing. Accordingly, a decryption function need not be mounted on the firewall 20.

Further, the firewall 20 controls data transfer from the client 30 to the specific port of the server 10. Thus, the client 30 may only transmit a command and need not mount other specific functions on the client 30.

In the above-described embodiment, the firewall 20 invalidates data transfer from the client 30 to the specific port of the server 10 when the predefined time period has elapsed from the time point where the identification information of the specific port is received from the server 10. As a result, a time period during which the port has been released is restricted. Thus, an unauthorized access made via the port can be suppressed so that security can be enhanced.

Further, in the above-described embodiment, the firewall 20 stores the validation setting information including the port identification information received from the server 10, to validate data transfer from the client to the port, which is represented by the port identification information, of the server. The firewall 20 transfers, upon receiving the data acquisition request from the client 30, the data acquisition request to the port, which is represented by the port identification information received together with the data acquisition request, of the server 10 when the validation setting information including the port identification information received together with the data acquisition request is stored. As a result, the firewall 20 can transfer the data acquisition request to only the port of the server 10 to which data transfer has previously been validated.

Further, in the above-described embodiment, the firewall 20 stores the validation setting information including the port identification information received from the server 10 and the protocol identification information, to validate data transfer from the client 30 to the port, which is represented by the port identification information, of the server 10. The firewall 20 transfers, upon receiving the data acquisition request from the client 30, the data acquisition request to the port, which is represented by the port identification information received together with the data acquisition request, of the server 10 when the validation setting information including the port identification information received together with the data acquisition request is stored and the protocol used to transmit the data acquisition request and the protocol represented by the protocol identification information included in the validation setting information match each other. As a result, the firewall 20 can transfer the data acquisition request to the server 10 using the previously set protocol.

Further, in the above-described embodiment, the firewall 20 stores the validation setting information including the port identification information received from the server 10 and the IP address of the client 30, to validate data transfer from the client 30 to the port, which is represented by the port identification information, of the server 10. The firewall 20 transfers, upon receiving the data acquisition request from the client 30, the data acquisition request to the port, which is represented by the port identification information received together with the data acquisition request, of the server 10 when the validation setting information including the port identification information received together with the data acquisition request is stored and the transmission source IP address of the data acquisition request and the IP address of the client 30 included in the validation setting information match each other. As a result, the firewall 20 can transfer the data acquisition request to the server 10 using a previously set destination IP address and the port. Accordingly, even when the FTPS is used, a probability that respective port connection scanning from an indefinite number of clients can be reduced so that security can be enhanced.

Further, in the above-described embodiment, the server 10 selects the identification information of the dedicated port to be used to provide the target data to the client 30 among the plurality of ports, and transmits the selected port identification information to the firewall 20. As a result, the dedicated port to be used to provide the target data is not used for other uses, for example, establishment of the communication connection between the server 10 and the client 30, whereby an unauthorized access to the target data can be prevented.

### Second Example Embodiment

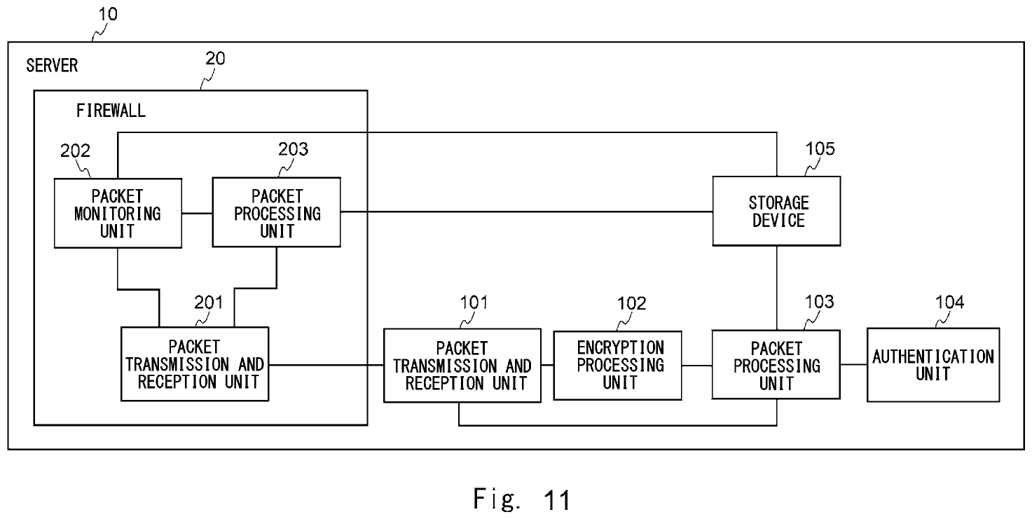

FIG. 11 is a diagram illustrating a configuration of a server 10 according to a second example embodiment of the present disclosure. In the second example embodiment, a function of a firewall 20 is mounted on the server 10. That is, the server 10 is configured to include the firewall 20. The server 10 includes a packet transmission and reception unit 201, a packet monitoring unit 202, and a packet processing unit 203, described above, in addition to a plurality of packet transmission and reception units 101, an encryption processing unit 102, a packet processing unit 103, an authentication unit 104, and a storage device 105, described above. The packet processing unit 103 and the packet transmission and reception unit 201 communicate data to each other via a network in the server 10. An arithmetic device in the server 10 reads out and executes a communication program from the storage device 105, to perform the communication method according to the first example embodiment of the present disclosure. The storage device 105 further stores information to be stored in the storage device 204.

In the above-described example, the program includes instructions (or software codes) that, when loaded into a computer, cause the computer to perform one or more of the functions described in the embodiments. The program may be stored in a non-transitory computer readable medium or a tangible storage medium. By way of example, and not a limitation, non-transitory computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals. The present disclosure is not limited to the above-described embodiments,

but can be appropriately changed without departing from the scope and spirit of the disclosure. The first and second example embodiments can be combined as desirable by one of ordinary skill in the art.

The present disclosure makes it possible to provide, in a communication system using an FTPS, a communication system capable of controlling data transfer from a client to a specific port of a server, a communication method, and a communication program.

What is claimed is:

1. A communication system using an FTPS (File Transfer Protocol over Secure socket layer/transport layer security), the communication system comprising:
a server having a plurality of ports; and
a firewall functioning between the server and a client, wherein
the server transmits, upon receiving a command transmitted by the client, identification information of one of the plurality of ports in an unencrypted state to the firewall, and
the firewall validates, upon receiving the port identification information from the server, data transfer from the client to the port, which is represented by the port identification information, of the server.

2. The communication system according to claim 1, wherein the firewall invalidates, when a predefined time period has elapsed from a time point where the port identification information is received from the server, data transfer from the client to the port, which is represented by the port identification information, of the server.

3. The communication system according to claim 1, wherein the firewall does not transfer to the client the port identification information, which remains unencrypted, received from the server.

4. The communication system according to claim 1, wherein the firewall
stores validation setting information including the port identification information received from the server, to validate data transfer from the client to the port, which is represented by the port identification information, of the server, and
transfers, upon receiving a data acquisition request from the client, the data acquisition request to the port, which is represented by the port identification information received together with the data acquisition request, of the server when the validation setting information including the port identification information received together with the data acquisition request is stored.

5. The communication system according to claim 1, wherein the firewall
stores validation setting information including the port identification information received from the server and protocol identification information, to validate data transfer from the client to the port, which is represented by the port identification information, of the server, and
transfers, upon receiving a data acquisition request from the client, the data acquisition request to the port, which is represented by the port identification information received together with the data acquisition request, of the server when the validation setting information including the port identification information received together with the data acquisition request is stored and a protocol used to transmit the data acquisition request and a protocol represented by the protocol identification information included in the validation setting information match each other.

6. The communication system according to claim 1, wherein the firewall
stores validation setting information including the port identification information received from the server and an IP address of the client, to validate data transfer from the client to the port, which is represented by the port identification information, of the server, and
transfers, upon receiving a data acquisition request from the client, the data acquisition request to the port, which is represented by the port identification information received together with the data acquisition request, of the server when the validation setting information including the port identification information received together with the data acquisition request is stored and a transmission source IP address of the data acquisition request and an IP address of the client included in the validation setting information match each other.

7. The communication system according to claim 1, wherein the server selects identification information of a dedicated port to be used to provide target data to the client among the plurality of ports, and transmits the selected port identification information to the firewall.

8. The communication system according to claim 1, wherein the server includes the firewall.

9. A communication method comprising:
a server having a plurality of ports using an FTPS receiving a command from a client via a firewall functioning between the server and the client;
the server transmitting identification information of one of the plurality of ports in an unencrypted state to the firewall;
the firewall receiving identification information of the port of the server from the client; and
the firewall validating data transfer from the client to the port, which is represented by the port identification information, of the server.

10. A non-transitory computer readable medium storing a communication program to be executed by an information processing device functioning as a server having a plurality of ports using an FTPS, the non-transitory computer readable medium causing the information processing device to perform to:
receive a command transmitted by a client; and
transmit identification information of one of the plurality of ports in an unencrypted state to a firewall included in the information processing device so that the firewall validates data transfer from the client to the port, which is represented by the port identification information, of the server.
